(19) United States
(12) Patent Application Publication
(10) Pub. No.: US 2021/0046855 A1
(43) Pub. Date: Feb. 18, 2021

(54) VEHICLE SEAT WITH IMPROVED STORAGE SPACE AND ASSOCIATED VEHICLE

(71) Applicant: SpeedInnov, Paris (FR)

(72) Inventors: Christophe PAILLER, PERIGNY (FR); David Jérôme MARTIN, SAINTE SOULLE (FR)

(21) Appl. No.: 16/991,201

(22) Filed: Aug. 12, 2020

(30) Foreign Application Priority Data
Aug. 12, 2019 (FR) 19 09151

(51) Int. Cl. B60N 2/90; B60N 2/005; B61D 33/00

(52) U.S. Cl. CPC B60N 2/90; B61D 33/0007; B60N 2/005

(57) ABSTRACT

The invention relates to a vehicle (10) seat (22), comprising:
a seat bottom (26);
a backrest (28) secured to the seat bottom (26), and
at least one leg (32) supporting the seat bottom (26).

The leg (32) comprises at least three segments (44, 46, 48), including:
a first segment (44) fastened to the lower face (40) of the seat bottom (26),
a second segment (46) fastened to the floor (20, 21) of the vehicle (10), and
a third segment (48) joining the first segment (44) and the second segment (46).
   The third segment (48) is arranged so that the leg (32) defines a housing (50) between the seat bottom (26) and the floor (20, 21).

The housing (50) is able to accommodate at least one piece of carry-on luggage (52) such that it does not protrude by more than 100 mm from the front edge (34) or the rear edge (36) of the seat bottom (26).

The present invention relates to a vehicle seat, comprising:
a seat bottom, having a front edge and a rear edge spaced apart from one another along the longitudinal direction and delimiting a seat bottom surface, as well as an upper face and a lower face spaced apart from one another along an elevation direction,
a backrest secured to the seat bottom near the rear edge, and
at least one leg supporting the seat bottom.

It is known to place seats in the compartments of vehicles intended to accommodate passengers, so as to allow them to sit down to make their journey more pleasant. This is in particular the case for vehicles intended to make medium to long journeys, such as rail or road vehicles, as well as for maritime or air vehicles.

The design of passenger compartments requires taking account of both the space occupied by the seats for the passengers and the areas intended for the luggage of these passengers, by providing areas intended to store them for the duration of the trip.

The luggage is generally classified into two categories: bulky luggage, requiring a specific storage area, and carry-on luggage, with a smaller size, intended to be stored near the passenger.

In particular, it is known to provide luggage racks arranged above the seats, to accommodate passengers' carry-on luggage.

However, these luggage storage areas can still be improved.

Indeed, these luggage racks in the upper part of the cabin are generally bothersome for passengers who stand up. Additionally, it is sometimes difficult to store very heavy luggage in a luggage rack located overhead. Furthermore, this luggage can fall and endanger passengers.

Lastly, in the case of vehicles with two or more floors, the height under the ceiling is limited, which makes it difficult to place a luggage rack above passengers' seats.

One aim of the invention is thus to provide a luggage storage area minimizing the space occupied in the compartment, with simpler and secure access, and that is compatible with vehicles having two floors.

To that end, the invention relates to a seat of the aforementioned type, wherein the leg comprises at least three segments, including:
a first segment, extending substantially in the longitudinal direction, fastened to the lower face of the seat bottom,
a second segment, extending substantially in the longitudinal direction, intended to be fastened to a vehicle cabin floor spaced apart from the first segment in the elevation direction, and
a third segment, extending substantially in the elevation direction joining the first segment and the second segment,
the third segment being arranged so that the leg is able to define, with a floor, a housing extending between the lower face of the seat bottom and the floor,
the housing being able to accommodate at least one piece of carry-on luggage such that the carry-on luggage does not protrude by more than 100 mm from the front edge or the rear edge of the seat bottom, in the longitudinal direction.

Such a seat makes it possible to have a storage area below the seat bottom suitable for receiving a piece of carry-on luggage, without additional bother for the occupant of the seat or his neighbors. Additionally, the luggage thus stored is easily accessible and does not pose any fall risk. Lastly, such storage of the luggage items makes it possible to free space below the ceiling by eliminating the need for a luggage rack above the seat, and is particularly suitable for vehicles with several levels.

According to specific embodiments, the seat according to the invention includes one or more of the following features, considered alone or according to any technically possible combination(s):
the third segment extends at a distance greater than or equal to 350 mm from the front edge or the rear edge of the seat bottom, the distance being measured in the longitudinal direction, in a plane parallel to the longitudinal direction and the elevation direction, the third segment advantageously having a length measured in the elevation direction greater than or equal to 250 mm;
the segments of the leg are arranged so as to form a C-shaped profile in the plane parallel to the longitudinal direction and the elevation direction;
the seat comprises a single leg located near a first side edge of the seat bottom in a transverse direction, the seat being arranged to be fastened to a vehicle body near a second side edge of the seat bottom, the first side edge and the second side edge joining the front and rear edges on either side of the seat bottom surface;
the seat defines at least two locations, each location being able to accommodate a seated passenger;
the housing is able to receive at least as many pieces of carry-on luggage as the seat is able to accommodate passengers, each piece of carry-on luggage having a length of less than or equal to 550 mm, a width of less than or equal to 350 mm and a height of less than or equal to 250 mm;
the housing is able to receive at least one of the luggage items oriented with its height along the longitudinal direction and at least one other of the luggage items oriented with its height along a transverse direction;
the third segment of the leg has a cross-section, in a horizontal plane, whose surface increases going from the first segment to the second segment of the leg; and
the leg is made from a composite material comprising carbon fibers.

The invention also relates to a vehicle, in particular a rail vehicle, comprising at least one cabin, the cabin comprising a plurality of seats as described above.

According to one specific embodiment, the vehicle according to the invention has the following feature:
the vehicle comprises at least one car with several levels, each level comprising a cabin.

The invention will be better understood upon reading the following description, provided solely as example and in reference to the accompanying drawings, in which:

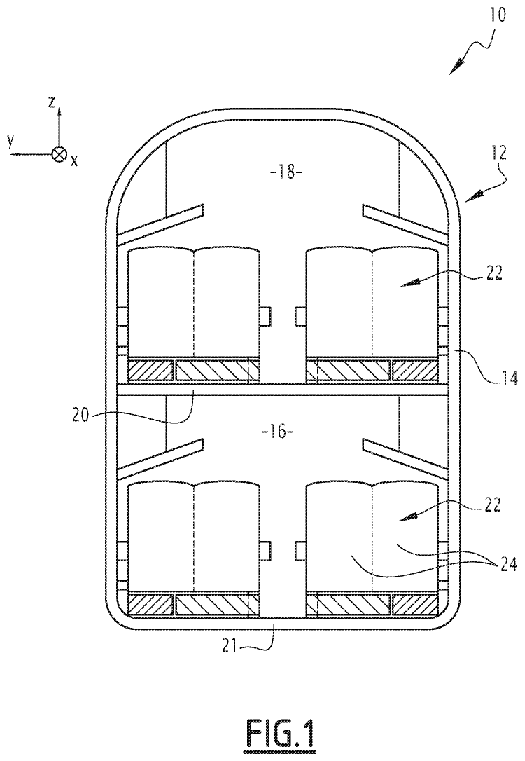

FIG. 1 is a cross-sectional view of a vehicle according to the invention;

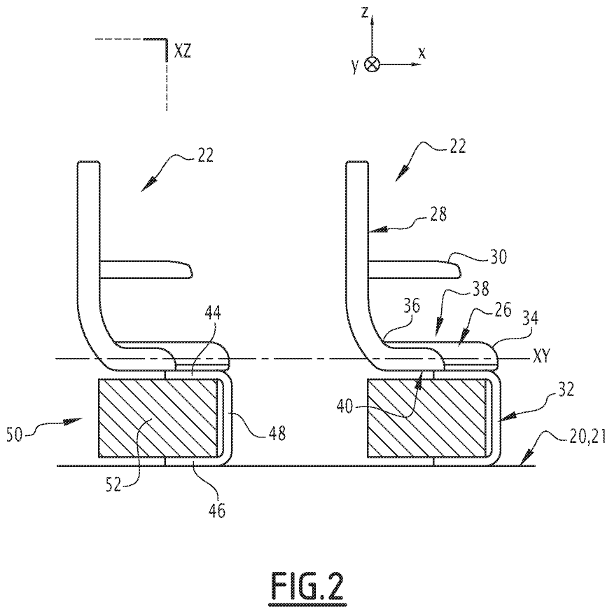

FIG. 2 is a side view of two seats according to a first embodiment of the invention;

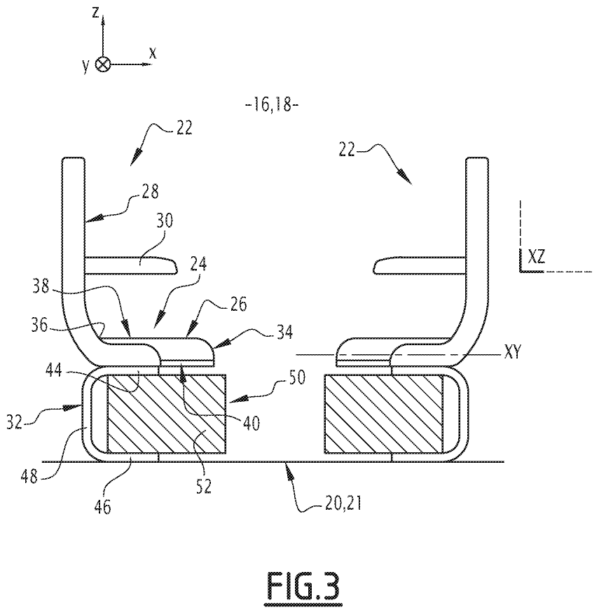

FIG. 3 is a side view of two seats according to a second embodiment of the invention; and

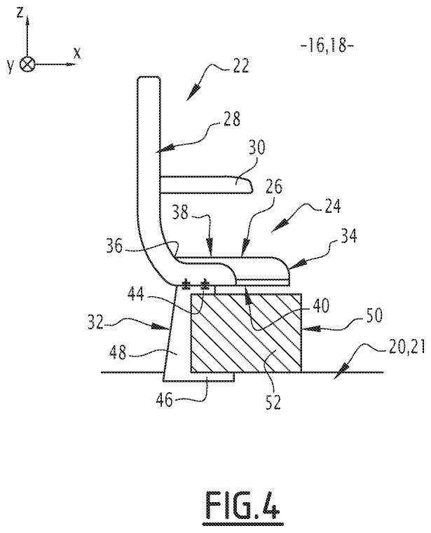

FIG. 4 is a side view of a seat according to a third embodiment of the invention.

A rail vehicle 10 is shown in FIG. 1, comprising a car 12 with two levels.

Hereinafter, reference is made to a longitudinal direction X extending substantially along the normal direction of movement of the vehicle 10, a transverse direction Y orthogonal to the longitudinal direction X and substantially horizontal, and a substantially vertical elevation direction Z, as shown in FIG. 1.

Additionally, hereinafter, “substantially along a direction”, “substantially parallel” and “substantially perpendicular” respectively mean “along a direction”, “parallel to” and “perpendicular to” to within 10°, and in particular to within 5°.

The car 12 comprises a body 14 delimiting a lower level 16 and an upper level 18 that are separated by an intermediate floor 20 of the upper level 18. The body 14 also defines a lower floor 21 for the lower level 16.

Each of the lower level 16 and the upper level 18 comprises a cabin intended to accommodate passengers, each cabin comprising seats 22 intended to allow the passengers to travel seated.

According to the embodiment of FIG. 1, each seat 22 of the cabin defines at least two receiving locations 24 able to accommodate a seated passenger.

According to another embodiment, at least one of the seats 22 defines a single location 24 able to accommodate a seated passenger, in particular half of the seats 22 comprised in the cabin.

As shown in FIG. 2, each seat 22 comprises a seat bottom 26 defining a seating surface, a backrest 28, at least one armrest 30 and at least one leg 32.

The seat bottom 26 extends substantially in a plane XY parallel to the longitudinal direction X and to the transverse direction Y. The seat bottom 26 has a front edge 34 and a rear edge 36 that are spaced apart from one another relative to the longitudinal direction X, two lateral edges that are spaced apart from one another relative to the transverse direction Y, as well as an upper face 38 and a lower face 40 that are spaced apart from one another relative to the elevation direction Z.

The backrest 28 is secured to the seat bottom 26, near the rear edge 36. The backrest 28 is substantially planar and forms an angle with the plane XY of the seat bottom 26, for example inclusively between 75° and 90°.

The or each armrest 30 is fastened to the backrest 28 and/or the seat bottom 26, fixed or movably in rotation about an axis parallel to the transverse direction Y. Each armrest 30 is for example arranged near a transverse edge of a location 26 in the longitudinal direction X.

According to a first variant, the seat 22 comprises a leg 32 near each of the side edges of the seat bottom 26.

According to another variant, the seat 22 comprises a single leg 32 near one of the side edges of the seat bottom 26 and is fastened directly to a wall of the body 14 by a fastening member arranged near the other side edge of the seat bottom 26.

Each leg 32 is secured to the lower face 40 of the seat bottom 26 and the corresponding floor 20, 21, so as to support the seat bottom 26.

The leg 32 comprises a first segment 44 and a second segment 46 both extending substantially in the longitudinal direction X, and a third segment 48 extending substantially in the elevation direction Z.

The first segment 44 and the second segment are spaced apart from one another in the elevation direction Z and are joined to one another by the third segment 48.

Advantageously, the segments 44, 46, 48 of each leg 32 are arranged so as to form a C-shaped profile in the plane XZ parallel to the longitudinal direction X and the elevation direction Z.

The leg 32 is made from a rigid material, for example metal, in particular steel, or advantageously from a composite material comprising carbon fibers.

Advantageously, the first segment 44, the second segment 46 and the third segment 48 are integral with one another. For example, in the embodiment of FIG. 2, the leg 32 is formed by bending a bar or a rectilinear profile in order to form the first segment 44, the second segment 46 and the third segment 48.

The first segment 44 is fastened to the lower face 40 of the seat bottom 26 and the second segment 46 is fastened to the floor of the cabin, for example by welding when the respective materials of the leg 32, the floor 20, 21 and the seat bottom 26 allow it. In a variant, the first segment 44 is fastened to the seat bottom 26 using fastening members such as screws or rivets, or glued to the seat bottom 26, and the second segment 46 is fastened to the floor 20, 21 by similar fastening members, or welded.

Thus, the seat 22 defines, with the floor of the cabin, a housing 50 extending between the lower face 40 of the seat bottom 26 and the floor 20, 21, the housing 50 being able to receive at least one piece of carry-on luggage 52.

The third segment 48 of the leg 32 forms a bottom stop of the housing 50, which limits the depth of the housing 50 and thus limits the width of the carry-on luggage 52 received in the housing 50. Thus, the carry-on luggage 52 does not protrude from the front edge 34 in the longitudinal direction X.

Advantageously, the third segment 48 extends at a distance greater than or equal to 350 mm from the rear edge 36 of the seat bottom 26, the distance being measured in the longitudinal direction X, in the plane XZ parallel to the longitudinal direction X and the elevation direction Z.

Thus, the housing 50 has a depth, measured in the longitudinal direction X, greater than or equal to 350 mm. The housing 50 is then able to receive the carry-on luggage 52 without the latter protruding by more than 100 mm from the rear edge 36 of the seat bottom 26 in the longitudinal direction X.

Advantageously, the protrusion of the carry-on luggage 52 past the rear edge 36 is nil.

The third segment 48 has a length greater than or equal to 250 mm, the length of the third segment 48 being measured in the elevation direction Z, in the plane XZ, between the first segment 44 and the second segment 46.

Advantageously, each of the segments 44, 46, 48 of the leg 32 has a thickness in the transverse direction Y greater than or equal to the length of the third segment 48, so that the leg 32 has a significant stiffness for passenger comfort.

The positioning of the third segment 48 is such that the housing 50 is accessible from behind the seat 22. The housing 50 is then intended to receive the luggage 52 of the passenger occupying the seat 22 located behind that defining the housing 50.

A carry-on luggage item means that the luggage item 52 has a length of less than or equal to 550 mm, a width of less than or equal to 350 mm and a height of less than or equal to 250 mm.

More generally, the housing 50 is suitable for receiving at least as many carry-on luggage items as the seat 22 has locations.

For example, in the case where the seat 22 defines two locations 24, the housing 50 is able to receive two pieces of carry-on luggage 52.

As shown in FIG. 1, when the width of the seat 22 is too small to allow the luggage items 52 to be arranged in the same direction, in particular if the seat 22 is of the second class type and comprises a single leg 32, the two carry-on luggage items 52 are arranged in an L shape. This means that the luggage item 52 closest to the leg 32 is arranged with its length substantially along the transverse direction Y while the second luggage item 52, close to the walls of the body 14, is arranged with its length substantially along the longitudinal direction X.

In a variant, when the width of the seat 22 along the transverse direction Y allows it, in particular if the seat 22 is of the first class type, the two carry-on luggage items 52 are arranged in the same direction, with the length of each luggage item 52 oriented substantially in the transverse direction Y.

A seat 22 according to a second embodiment is shown in FIG. 3. The seat 22 according to the second embodiment is identical to the seat 22 according to the first embodiment described above, the corresponding elements bearing the same references, with the exception of the following.

In this second embodiment, the leg 32 is arranged such that the housing 50 is accessible from the front of the seat 22. The housing 50 is then intended to receive the luggage 52 of the passenger occupying the seat 22 defining the housing 50.

Advantageously, the third segment 48 extends at a distance greater than or equal to 350 mm from the front edge 34 of the seat bottom 26, the distance being measured in the plane XZ parallel to the longitudinal direction X and the elevation direction Z.

The housing 50 thus has a depth suitable for receiving the carry-on luggage item 52 without the latter protruding excessively from the front edge 34 of the seat 22 in the longitudinal direction X. The maximum protrusion of the carry-on luggage item 52 is less than 100 mm, and advantageously the protrusion of the carry-on luggage item 52 is nil.

The leg 32 forms a bottom stop of the housing 50, such that the luggage item 52 also does not protrude from the rear edge 36 of the seat bottom 26 along the longitudinal direction X.

The seat 22 according to this embodiment is advantageous in the case of seats 32 arranged facing one another, as shown in FIG. 3, so as to allow the travelers occupying them to have a dedicated storage area.

A seat 22 according to a third embodiment is shown in FIG. 4. The seat 22 according to the third embodiment is identical to the seat 22 according to the first embodiment described above, the corresponding elements bearing the same references, with the exception of the following.

The leg 32 comprises a third segment 48 having a cross-section, in a horizontal plane XY, whose surface increases going from the first segment 44 to the second segment 46. The leg 32 is typically made by welding the three segments 44, 46, 48 to one another, or by molding, based on the material making up the leg 32.

The leg 32 is fastened to the lower face 40 of the seat bottom 26 by fastening members, for example bolts.

The leg 32 according to the embodiment of FIG. 4 has a greater stiffness, and therefore improved stability, as well as a greater mechanical strength. It is, however, more complex to produce than the variants described above.

According to variants that are not shown, the vehicle 10 is a road vehicle, for example a coach bus, in particular a double-decker coach bus, or a maritime or air vehicle.

The seat 22 according to the invention makes it possible to reduce the space requirement below the seat 22, which makes it possible to use the volume between the seat bottom 26 and the floor 20, 21 to store luggage items. This makes it possible to free up the area intended to store luggage items elsewhere in the vehicle in order to increase the number of locations for passengers, which is desirable in any type of vehicle, and in particular in second-class-type cabins.

Storage by a passenger of his luggage item 52 below the seat 22 also makes it possible to monitor this item more easily during the trip, and the luggage item 52 can simply be fastened to the leg 32, using a simple antitheft device, for example during movements by the passenger.

1. A vehicle seat, comprising:
a seat bottom, having a front edge and a rear edge spaced apart from one another along the longitudinal direction and delimiting a seat bottom surface, as well as an upper face and a lower face spaced apart from one another along an elevation direction,
a backrest secured to the seat bottom near the rear edge, and
at least one leg supporting the seat bottom,
wherein the leg comprises at least three segments, including:
a first segment, extending substantially in the longitudinal direction, fastened to the lower face of the seat bottom,
a second segment, extending substantially in the longitudinal direction, intended to be fastened to a vehicle cabin floor, spaced apart from the first segment in the elevation direction, and
a third segment, extending substantially in the elevation direction joining the first segment and the second segment,
the third segment being arranged so that the leg is able to define, with a floor, a housing extending between the lower face of the seat bottom and the floor,
the housing being able to accommodate at least one piece of carry-on luggage such that the carry-on luggage does not exceed 100 mm from the front edge or the rear edge of the seat bottom, in the longitudinal direction.

2. The seat according to claim 1, wherein the third segment extends at a distance greater than or equal to 350 mm from the front edge or the rear edge of the seat bottom, the distance being measured in the longitudinal direction, in a plane parallel to the longitudinal direction and the elevation direction.

3. The seat according to claim 1, wherein the segments of the leg are arranged so as to form a C-shaped profile in the plane parallel to the longitudinal direction and the elevation direction.

4. The seat according to claim 1, wherein the seat comprises a single leg located near a first side edge of the seat bottom in a transverse direction, the seat being arranged to be fastened to a vehicle body near a second side edge of the seat bottom, the first side edge and the second side edge joining the front and rear edges on either side of the seat bottom surface.

5. The seat according to claim 1, wherein the seat defines at least two locations, each location being able to accommodate a seated passenger.

6. The seat according to claim 5, wherein the housing is able to receive at least as many pieces of carry-on luggage as the seat is able to accommodate passengers, each piece of carry-on luggage having a length of less than or equal to 550 mm, a width of less than or equal to 350 mm and a height of less than or equal to 250 mm.

7. The seat according to claim 6, wherein the housing is able to receive at least one of the luggage items oriented with its height along the longitudinal direction and at least one other of the luggage items oriented with its height along a transverse direction.

8. The seat according to claim 1, wherein the third segment of the leg has a cross-section, in a horizontal plane, whose surface increases going from the first segment to the second segment of the leg.

9. A vehicle, in particular a rail vehicle, comprising at least one cabin, the cabin comprising a plurality of seats according to claim 1.

10. The vehicle according to claim 9, wherein the vehicle comprises at least one car with several levels, each level comprising a cabin.
